(19) United States
(12) Patent Application Publication
(10) Pub. No.: US 2025/0124336 A1
(43) Pub. Date: Apr. 17, 2025

(54) METHODS, SYSTEMS, AND COMPUTER READABLE MEDIA FOR USING A MACHINE LEARNING (ML) MODEL IN BATTERY MANAGEMENT

(71) Applicant: Keysight Technologies, Inc., Santa Rosa, CA (US)

(72) Inventors: Parul Mittal, Gwalior (IN); Sanjeev Kumar Gupta, Vasant Kunj (IN)

(21) Appl. No.: 18/380,506

(22) Filed: Oct. 16, 2023

(51) Int. Cl. G06N 20/00

(52) U.S. Cl. CPC G06N 20/00

(57) ABSTRACT

One example method for using a machine learning (ML) model in battery management comprises: receiving one or more selection inputs for selecting an ML model for providing battery management information, wherein the one or more selection inputs include a state of health (SOH) value associated with a battery system; selecting, using the selection inputs, the ML model from a plurality of ML models; obtaining, using model inputs and the ML model, the battery management information associated with the battery system; and performing, using the battery management information, a battery management decision for managing the battery system.

### TECHNICAL FIELD

The subject matter described herein relates to electric battery management. More particularly, the subject matter described herein relates to using a machine learning (ML) model in battery management.

### BACKGROUND

Recent statistics highlight the transformative impact of green energy on the automotive industry, with electric vehicle (EV) sales witnessing remarkable growth. This growth is accompanied by numerous security and safety issues, which has caused people great concern. One notable issue involves battery-related fires. The most common cause of battery-related fires is ineffective battery management, especially with regard to utilizing various battery metrics, such as a state of charge (SOC) value and a state of health (SOH) value. For example, a SOC value generated by a battery management system (BMS) may indicate the level of charge of a battery or a battery cell relative to its capacity (e.g., as a percentage), and a SOH value may indicate a battery's or a battery cell's health or condition (e.g., a SOH value that is less than 71% may indicate that a battery needs replacing). The SOC of a battery cell is generally used in maintaining its safe operation and lifetime during charging, discharging, and storage. However, the SOC of a battery cell cannot be measured directly and is typically estimated from other measurements and known parameters. As such, errors can occur when estimating the SOC of a battery cell and can result in inefficient or improper battery management, e.g., inability to utilize the full capability of the battery cell or overcharging. Further, inaccurate SOC and SOH values of a battery cell can cause or contribute security and safety issues, e.g., battery-related fires.

While techniques for estimating the SOC of a battery cell exist, such techniques (e.g., a chemical method, a voltage method, a current integration method (e.g., Coulomb counting), etc.) have limitations such as open loop issues, accuracy is compromised over battery age, requiring complex computation, limited support for certain battery types, and/or is non-adaptive to dynamic situations.

### SUMMARY

Methods, systems, and computer readable media for using a machine learning (ML) model in battery management are disclosed. One example method for using an ML model in battery management comprises: receiving one or more selection inputs for selecting an ML model for providing battery management information, wherein the one or more selection inputs include a state of health (SOH) value associated with a battery system; selecting, using the selection inputs, the ML model from a plurality of ML models; obtaining, using model inputs and the ML model, the battery management information associated with the battery system; and performing, using the battery management information, a battery management decision for managing the battery system.

According to one example system for using an ML model in battery management, the system includes a test system implemented using at least one processor and a memory. The system is configured for: receiving one or more selection inputs for selecting an ML model for providing battery management information, wherein the one or more selection inputs include a SOH value associated with a battery system; selecting, using the selection inputs, the ML model from a plurality of ML models; obtaining, using model inputs and the ML model, the battery management information associated with the battery system; and performing, using the battery management information, a battery management decision for managing the battery system.

The subject matter described herein may be implemented in software in combination with hardware and/or firmware. For example, the subject matter described herein may be implemented in software executed by a processor (e.g., a hardware-based or physical processor). In one example implementation, the subject matter described herein may be implemented using a non-transitory computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, such as field programmable gate arrays, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a diagram illustrating an example battery management environment including an adaptive battery manager;

FIG. 2 is a diagram illustrating an example battery management process using a machine learning (ML) model;

FIGS. 3A-3B are diagrams illustrating example battery management actions associated with battery management information;

FIG. 4 is a diagram illustrating root mean square error (RMSE) values associated with two ML models;

FIG. 5 is a diagram illustrating actual state of charge (SOC) values and predicted SOC values using a gradient boosting regressor (GBR) model; and

FIG. 6 is a block diagram illustrating an example process for using an ML model in battery management.

### DETAILED DESCRIPTION

The subject matter described herein relates to methods, systems, and computer readable media for using a machine learning (ML) model in battery management. In accordance with some aspects of the subject matter described herein, techniques, methods, equipment, systems, and/or mechanisms are disclosed for using an ML model in battery management. In some embodiments, an adaptive battery manager or other system in accordance with aspects described herein may be configured for receiving one or more selection inputs for selecting an ML model for providing battery management information, wherein the one or more selection inputs include a state of health (SOH) value associated with a battery system; selecting, using the selection inputs, the ML model from a plurality of ML models; obtaining, using model inputs and the ML model, the battery management information associated with the battery system; and performing, using the battery management information, a battery management decision for managing the battery system.

In accordance with some aspects of the subject matter described herein, an adaptive battery manager or other system in accordance with aspects described herein may be seamlessly integrated with a battery management system to enhance battery management features or capabilities. For example, an adaptive battery manager may be a microservice or logic that can interact with an existing battery management system to enhance its capabilities, such as by performing precise or improved estimation of a state of charge (SOC) for a battery using a best-fit ML model and various input (e.g., voltage, current, and temperature data for a battery and a state of health (SOH) value associated with the battery). In this example, the adaptive battery manager or a related battery management system may use an ML model-generated SOC prediction to determine appropriate battery management decisions (e.g., actions to prevent or mitigate thermal critical situations, control battery voltage or cutoff voltage, notify user or other entities of battery issues or potential issues).

Advantageously, some aspects of the present subject matter described herein provides various benefits over other, conventional battery management techniques and systems. For example, an adaptive battery manager or other system in accordance with aspects described herein can be adaptive or suitable for dynamic scenarios (e.g., by allowing various ML models to be dynamically selected and utilized based on current conditions), provide self-tuning of models, monitor modeling performance and utilize new or modified ML models, provide improved alert and notification mechanism, scalable, utilize a closed loop design for monitoring and regulation, provide accurate SOC prediction or estimation, and/or integrate easily with existing systems, devices, or mechanisms.

Reference will now be made in detail to various embodiments of the subject matter described herein, examples of which are illustrated in the accompanying drawings. Wherever possible, the same reference numbers will be used throughout the drawings to refer to the same or like parts.

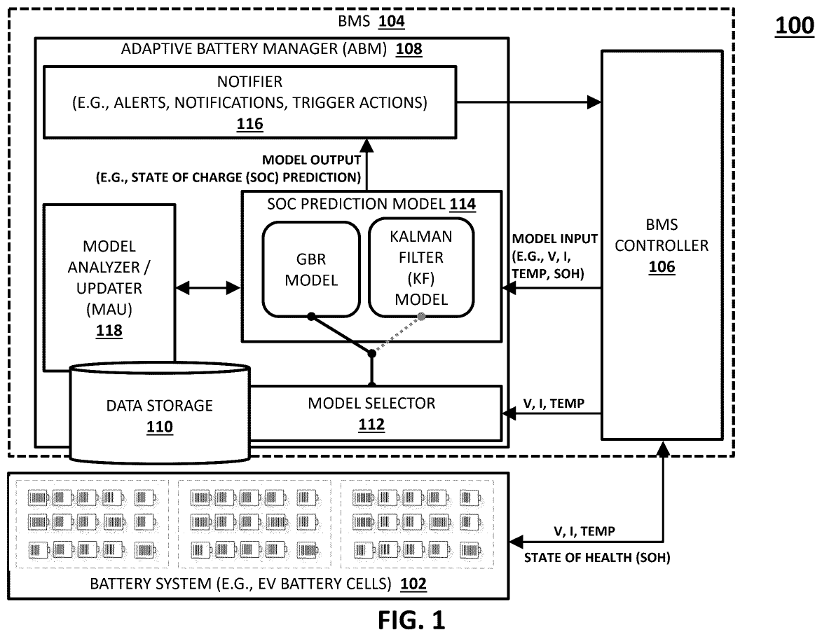

FIG. 1 is a diagram illustrating an example battery management environment 100 including an adaptive battery manager (ABM) 108. Environment 100 may include various entities associated with batteries and battery management. For example, environment 100 may include batteries, hardware, components, modules, sensors, chips, software executing on processors, or other entities associated with an electric vehicle (EV) or other battery-powered system. In this example, at least some entities may be interconnected, e.g., via a bus, a network, a switching fabric, or various links.

Referring to FIG. 1, environment 100 may include a battery system 102 and a battery management system (BMS) 104. Environment 100 may include various components or entities located on or at an EV or another battery powered device. For example, environment 100 may include hardware or other components located at or mounted on a chassis or body of an EV or another battery powered device.

Battery system 102 may represent a source of electric power consisting of one or more electrochemical cells with external connections for powering electrical devices. For example, battery system 102 may include a battery pack of lithium-ion cells or other type of battery cells. In this example, In some embodiments, battery system 102 may include or interact with battery sensors (e.g., devices that monitors battery data and/or provides the battery data to BMS 104 or other entities). Continuing with this example, battery system 102 may be located in an EV or on a related chassis (e.g., a car platform or frame).

BMS 104 may be any suitable entity or entities (e.g., software executing on a processor, an application-specific integrated circuit (ASIC), a field-programmable gate array (FPGA), or a combination of software, an ASIC, or an FPGA) for performing one or more aspects associated with managing battery system 102. In some embodiments, BMS 104 may be implemented using processor(s) (e.g., a physical processor, a general purpose microprocessor, a single-core processor, a multi-core processor, an FPGA, and/or an ASIC for executing software and/or logic) and/or memory for storing and executing data, logic, software, or other information.

In some embodiments, BMS 104 may manage or control charging of battery system 102 and may utilize battery sensors to obtain various battery data when determining battery management decisions. In some embodiments, BMS 104 may derive or estimate a state of charge (SOC) value associated with battery system 102. For example, SOC information is usable (e.g., by BMS 104) to ensure optimal performance and longevity of batteries and can indicate the amount of energy remaining in battery system 102. By precisely measuring the SOC of battery system 102, BMS 104 may optimize charging and discharging processes, prevent overcharging, prevent deep discharging, and ensure that battery system 102 operates within its safe operating range.

In some embodiments, SOC can be estimated using various algorithms and sensors that measured data such as voltage, current, and temperature data associated with battery system 102. The usage scope of SOC by BMS 104 or other systems is extensive and can be found in various sectors like electric vehicles, renewable energy systems, consumer electronics, and grid energy storage. For example, in EVs, SOC plays a very important role in monitoring and managing batteries' charge levels and optimizing performance and range.

In some embodiments, BMS 104 may determine or estimate a state of health (SOH) value associated with battery system 102. A SOH of a battery can provide useful insight for powering equipment and maintaining uptime in various industries, e.g., where battery performance and reliability are critical. For example, in EVs, SOH monitoring helps determine the overall health and remaining lifespan of an EV battery pack.

BMS 104 may include a BMS controller (BC) 106, an adaptive battery manager (ABM) 108, and/or a data storage 110. BC 106 may be any suitable entity or entities (e.g., software executing on a processor, an application-specific integrated circuit (ASIC), a field-programmable gate array (FPGA), or a combination of software, an ASIC, or an FPGA) for performing one or more aspects associated with controlling battery system 102 (e.g., starting, stopping, or pausing battery charging), communicating with battery sensors to obtain battery data, and/or interacting with ABM 108, users, or other entities. In some embodiments, BC 106 may also interact with various other system associated with an EV or other device powered by battery system 102. For example, after receiving output from ABM 108 regarding a battery's predicted SOC value, BC 106 may initiate or trigger various battery management actions, e.g., notifying a user (e.g., via a graphical user interface (GUI)), alerting a management system, and/or preventing or mitigating a battery safety issue (e.g., overcharging, deep discharging, etc.).

In some embodiments, BC 106 or another entity may collect, derive, or obtain battery data from one or more sensors associated with battery system 102 and may provide this data or related data (e.g., an SOH value derived or calculated using the battery data) to ABM 108.

ABM 108 may be any suitable entity or entities (e.g., software executing on a processor, an ASIC, an FPGA, or a combination of software, an ASIC, or an FPGA) for performing one or more aspects associated with generating battery management decision or related information, e.g., a predicted or estimated SOC value of battery system 102. For example, ABM 108 may utilize current battery data (e.g., voltage, current, and temperature data and/or a SOH value provided by BMS 104) to select an appropriate SOC prediction model 114 (e.g., a trained best-fit ML model) for predicting a current SOC value associated with battery system 102 and then use the predicted SOC value in generating battery management decisions (e.g., protection and notification actions), thereby enhancing BMS capabilities. In some embodiments, ABM 108 may be accessible as a microservice. For example, ABM software or logic may be located via a cloud platform or network and interacting with (e.g., by BMS 104 or other entities) via an application programming interface (API). In this example, the ABM software or logic may be programmed using Python or other programming languages and may be cross platform supported. In some embodiments, ABM 108 may be stored and run locally, e.g., data storage 110. For example, ABM software or logic may be integrated with BMS 104 or communicatively coupled to a local fabric or network (e.g., an EV communications network).

Data storage 110 may be any suitable entity or entities (e.g., a storage device, a non-transitory computer readable medium, or a storage system) for maintaining or storing information related to battery management, SOC prediction, ML modeling, training, or other actions. In some embodiments, data storage 110 may software, training data, trained ML models, training algorithms, historical battery data, battery safety information, predefined settings, user-provided input or settings, or other data. In some embodiments, data storage 110 may be located at BMS 104, ABM 108, another module or node, or distributed across multiple platforms or devices.

In some embodiments, ABM 108 may include entities (e.g., modules, software, logic, etc.) that performs particular actions or operations associated with determining battery management decisions. For example, as depicted in FIG. 1, ABM 108 may include a model selector 112 for using selection input (e.g., a SOH value and/or battery data) and selection rules for selecting an ML model for predicting a SOC value), SOC prediction model 114 for using model input (e.g., a SOH value and/or battery data) in predicting a SOC value, a model analyzer and/or updater (MAU) 116 for training, tuning, or updating ML models, and a notifier 118 for sending model output (e.g., a predicted SOC value) or battery management decisions (e.g., notifications, prevention actions, etc.) to BC 106 or other entities.

In some embodiments, ABM 108 or related entities thereof may overcome challenges of existing solutions (e.g., open loop issues, accuracy compromised over battery age, complex computations, unsupported battery types, and non-adaptive). For example, ABM 108 or related entities thereof may provide an Al-based or ML-based adaptive system that predicts accurate SOC values under dynamic situations. In this example, e.g., by utilizing current battery data to modify or update SOC prediction models, ABM 108 or related entities thereof can work in a closed loop manner and take effective actions (e.g., actions to prevent overcharging or over-discharging or thermal protection and/or notifications to users on the health, degradation or aging, proactive maintenance or replacement of a battery before a failure occurs).

In some embodiments, ABM 108 or related entities thereof may obtain battery related metrics (e.g., temperature, voltage, and current values) for battery system 102 or battery cells therein at intervals (e.g., every one or two seconds) and may obtain SOH values at the same interval or a different interval (e.g., every 30 seconds). In such embodiments, ABM 108 or related entities thereof may periodically or aperiodically utilize SOC prediction model 114 to determine or trigger new battery management decisions, e.g., after an amount of time has elapsed or after new data is obtained.

In some embodiments, ABM 108 or related entities thereof may provide or perform model monitoring, tuning, and updating. For example, MAU 118 may use historical data (e.g., battery data and corresponding model output) in monitoring the performance of an ML model (e.g., SOC prediction model 114) in real-time or near-real-time. In this example, MAU 118 may determine that the performance of the ML model needs improvement and, in response, may update or tune the ML model to improve performance.

In some embodiments, ABM 108 or related entities thereof may determine an ML model's performance when generating or training new models or tuning existing models and/or at various times during usage. For example, MAU 118 may receive SOC prediction values for battery system 102 from SOC prediction model 114 and compare that data to a set of actual or expected SOC values over the same period of time for battery system 102 (e.g., from a data store, a detection mechanism, a battery manufacturer or tester, or another source). In this example, MAU 118 may compute a root mean square error (RMSE) value using this data and if the compute RMSE value exceeds a threshold value (e.g., greater than 5%), MAU 118 may initiate an ML model update or tuning operation to improve the ML model's performance.

In some embodiments, ABM 108 or related entities thereof (e.g., model selector 112) may utilize selection rules or selection logic capable of dynamically selecting one of a plurality of ML models using selection input (e.g., a SOH value and/or battery data). In such embodiments, depending on current battery health and/or battery related metrics, SOC prediction model 114 may be selected to prolong or improve battery charging, battery longevity, and/or mitigate battery issues. For example, model selector 112 may select a gradient boosting regressor (GBR) model when a SOH value associated with battery system 102 is between 86% and 99% and may select a Kalman filter (KF) model when a SOH value associated with battery system 102 is between 71% and 85%.

In some embodiments, ABM 108 or related entities thereof (e.g., MAU 118) may generate new SOC prediction models or tune or update existing SOC prediction by using appropriate training data. For example, MAU 118 may receive battery data and SOH values from BMS 104 at various time intervals and may perform data cleanup or other operations to make the received data suitable for training purposes. In this example, data cleanup or other operations may involve removing duplicate data from each battery cell, removing data that is missing or incomplete for an observation instance, and/or separating or removing actual SOC values from received data such that the actual SOC values can be used as expected output or groundtruth values.

It will be appreciated that FIG. 1 is for illustrative purposes and that various nodes and/or modules, locations, and/or functionality described above in relation to FIG. 1 may be changed, altered, added, or removed.

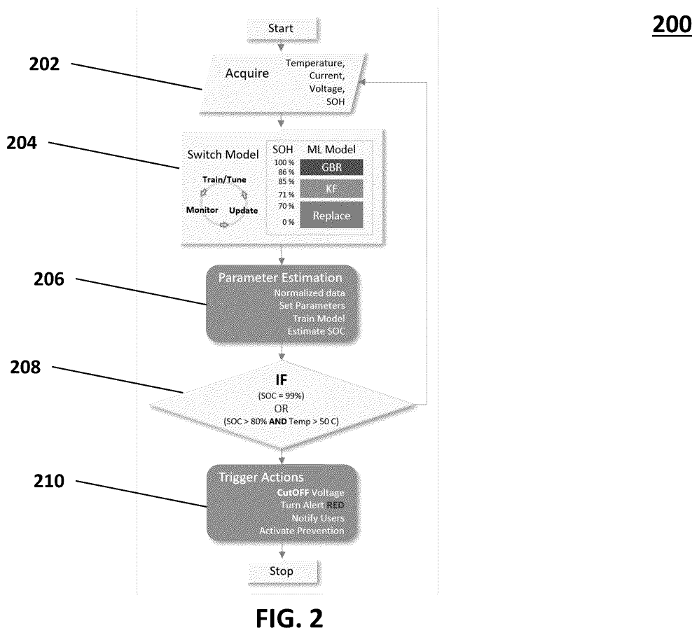

FIG. 2 is a diagram illustrating an example battery management process 200 using SOC prediction model 114. In some embodiments, example battery management process 200 may include steps 202, 204, 206, 208, and/or 210. In some embodiments, process 200, or portions thereof, may be performed by BMS 104, ABM 108, software or logic executing on a processor, and/or another node or module.

In some embodiments, ABM 108 may include a microservice that communicates with BMS 104 and/or is integrated with BMS 104. In such embodiments, process 200 may be executed by ABM 108 to generate or trigger one or more battery management decisions for managing an EV battery. For example, using process 200, ABM 108 may acquire temperature, current, and voltage data from battery sensors and SOH values from BMS 104 at periodic or aperiodic intervals. Based on the SOH value, ABM 108 may select one of a plurality of available ML models (e.g., SOC prediction models like a GBR model or a KF model) or may raise a flag or alert to replace a battery(s), e.g., if SOH is less than 70%. In this example, after the ML model is selected and engaged, ABM 108 may estimate and predict a battery's SOC value using the temperature, current, and voltage data. Continuing with this example, ABM 108 or a related ML model may keep monitoring battery characteristics and take appropriate action(s), e.g., according to updated SOC, voltage, and temperature values.

In some embodiments, process 200 may represent actions that ABM 108 or BMS 104 performs when determining that a predicted SOC value and/or a battery metric indicates a potential battery safety issue and, in response, triggering a mitigation event and/or notifying an entity regarding the mitigation event or the potential battery safety issue.

Referring to process 200, in step 202, battery data, such as temperature, current, and voltage data and SOH values, may be obtained from one or more sources. For example, ABM 108 may acquire temperature, current, and voltage data from battery sensors and SOH values from BMS 104.

In step 204, an appropriate SOC prediction model 114 may be selected using one or more of the battery data. For example, ABM 108 may use a selection algorithm that selects a particular ML model from a plurality of available models based on a SOH value.

In some embodiments, ABM 108 or a related entity (e.g., MAU 118) may use historical data, monitored data, and/or other information to tune existing models or train new models for future selection and usage.

In step 206, parameter estimation and/or related actions may be performed using SOC prediction model 114 for obtaining a predicted or estimated SOC value using one or more of the battery characteristics. For example, ABM 108 or a related entity may normalize received battery data, train or tune the model or parameters thereof, and then obtain a predicted or estimated SOC value from the model using the battery data.

In step 208, it may be determine whether a potential battery safety issue exists using the predicted or estimated SOC value and/or other battery data. For example, ABM 108 or a related entity may determine that a potential battery safety issue (e.g., overcharging or fire hazard) exists if the predicted or estimated SOC value is 99% of if the predicted or estimated SOC value is higher than 80% and the current battery temperature is greater than 50° Celsius (122° Fahrenheit).

In step 210, in response to determining that a potential battery safety issue exists, one or more mitigate or protection actions may be triggered or performed. For example, ABM 108 or another entity (e.g., BMS 104) may trigger or cause charging to stop (e.g., cutting off the voltage to battery system 102), causing a ‘red’ alert and/or notification to a management system, a GUI, or a user, and/or perform other prevention or mitigation actions.

It will be appreciated that process 200 is for illustrative purposes and that different and/or additional actions may be used. It will also be appreciated that various actions described herein may occur in a different order or sequence.

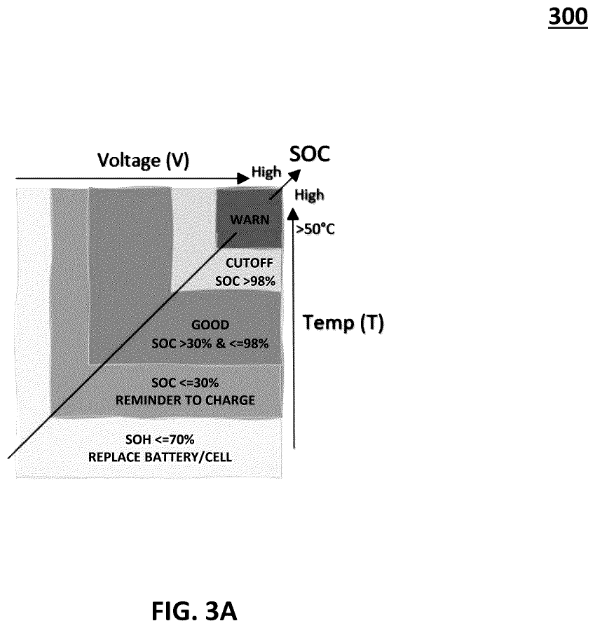

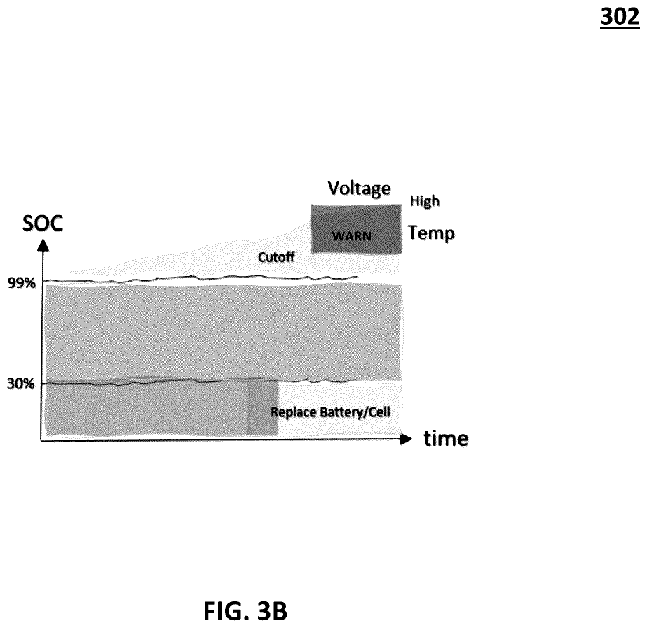

FIGS. 3A-3B are diagrams 300-302 illustrating example battery management actions associated with battery management information. In some embodiments, battery management decisions or related logic may be based on various criteria, scenarios, or conditions.

Referring to FIG. 3A, diagram 300 depicts various battery management actions in response to various criteria, scenarios, or conditions. As depicted in diagram 300, ABM 108 or another entity may notify or alert a user that a battery or battery cell needs to be replaced when a SOH value is 70% or less.

Diagram 300 indicates that a reminder (e.g., an alert or a notification) is needed when a low/no charge scenario is detected. For example, when the battery or battery cell has a low SOC (e.g., the predicted or estimated SOC value is 30% or lower), ABM 108 or another entity may detect a low/no charge scenario and, in response, notify or alert a user that a battery or battery cell needs to be (re) charged.

Diagram 300 indicates that no alerts or notification are needed when a battery or battery cell is charging as expected (e.g., within an acceptable range). For example, when the predicted or estimated SOC value of a battery or battery cell is between 31% and 98%, ABM 108 or another entity may determine that mitigation or protection actions are not needed.

Diagram 300 indicates that charging may be stopped (e.g., a cutoff event) and/or an alert or notification may be sent to a user for indicating that charging should be stopped when a predicted or estimated SOC value has reached a threshold value. For example, when the predicted or estimated SOC value of a battery or battery cell is above 98%, ABM 108 or another entity (e.g., SOC prediction model 114) may determine that mitigation or protection actions are needed. In this example, ABM 108 or BMS 104 may initiate a cutoff event (e.g., to stop charging battery system 102) in response to determining that an unsafe or potential unsafe condition exist (e.g., overcharging).

Diagram 300 indicates that ABM 108 or another entity may utilize SOC values and/or other criteria to determine whether an unsafe or potential unsafe condition exist and, if so, ABM 108 or another entity may trigger or cause battery management actions, e.g., a mitigation or protection action. For example, when the predicted or estimated SOC value of a battery or battery cell is above 80% and a battery or battery cell temperature is greater than 50° Celsius, ABM 108 or another entity (e.g., SOC prediction model 114) may determine that mitigation or protection actions are needed, such as engaging a voltage or charging cutoff, activating a cooling system, and/or alerting a user or other system. In another example, when a battery or battery cell temperature or voltage is greater than a threshold value, ABM 108 or another entity (e.g., SOC prediction model 114) may determine that mitigation or protection actions are needed, such as engaging a voltage or charging cutoff, activating a cooling system, and/or alerting a user or other system.

Referring to FIG. 3B, diagram 302 depicts various battery management actions in the time domain with regard to various information, such as predicted or estimated SOC values, battery voltage values, and battery temperatures. As depicted in diagram 302, ABM 108 or another entity may notify or alert a user that a battery or battery cell needs to be charged or replaced. For example, if after a particular amount of time (e.g., 2 hours) the battery or battery cell does not appear to be charging as expected (e.g., the predicted or estimated SOC value does not increase above 30%) then ABM 108 or another entity may notify or alert a user that a battery or battery cell needs to be replaced. In another example, when the battery or battery cell has a low SOC (e.g., the predicted or estimated SOC value is 30% or lower), ABM 108 or another entity may detect a low/no charge scenario and, in response, notify or alert a user that a battery or battery cell needs to be (re)charged.

Diagram 302 indicates that no alerts or notification are needed when a battery or battery cell is charging as expected (e.g., within an acceptable range). For example, when the predicted or estimated SOC value of a battery or battery cell is between 31% and 98%, ABM 108 or another entity may determine that mitigation or protection actions are not needed.

Diagram 302 indicates that charging may be stopped (e.g., a cutoff event) and/or an alert or notification may be sent to a user for indicating that charging should be stopped when a predicted or estimated SOC value has reached a threshold value. For example, when the predicted or estimated SOC value of a battery or battery cell is above 98%, ABM 108 or another entity (e.g., SOC prediction model 114) may determine that mitigation or protection actions are needed. In this example, ABM 108 or BMS 104 may stop charging battery system 102 in response to determining that an unsafe or potential unsafe condition exist (e.g., overcharging).

Diagram 302 indicates that ABM 108 or another entity may utilize SOC values and/or other criteria to determine whether an unsafe or potential unsafe condition exist and, if so, ABM 108 or another entity may trigger or cause battery management actions, e.g., a mitigation or protection action. For example, when the predicted or estimated SOC value of a battery or battery cell is above 80% and a battery or battery cell temperature is greater than 50° Celsius, ABM 108 or another entity (e.g., SOC prediction model 114) may determine that mitigation or protection actions are needed, such as engaging a voltage or charging cutoff, activating a cooling system, and/or alerting a user or other system. In another example, when a battery or battery cell temperature or voltage is greater than a threshold value, ABM 108 or another entity (e.g., SOC prediction model 114) may determine that mitigation or protection actions are needed, such as engaging a voltage or charging cutoff, activating a cooling system, and/or alerting a user or other system.

It will be appreciated that FIGS. 3A-3B are for illustrative purposes and that various functionality described above in relation to FIGS. 3A or 3B may be changed, altered, added, or removed.

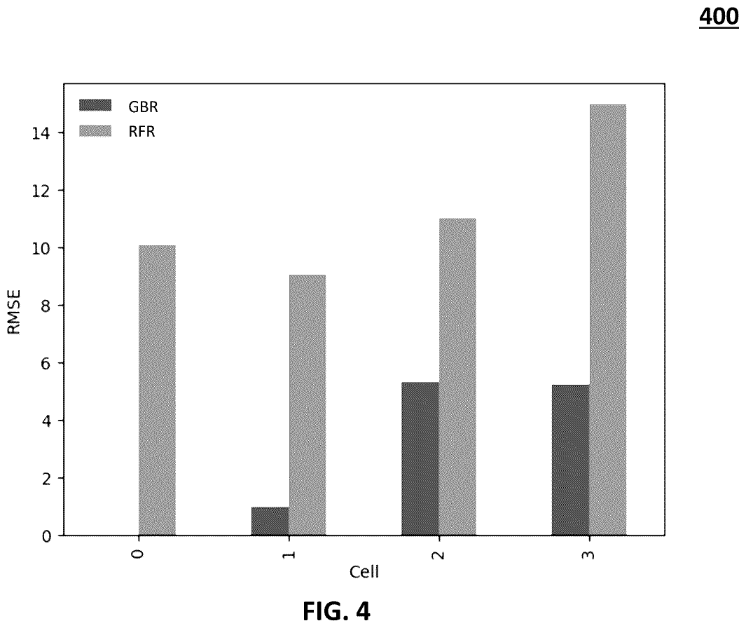

FIG. 4 is a diagram 400 illustrating RMSE values associated with two ML models usable by ABM 108. In some embodiments, ABM 108 may select a best-fit AI/ML model for particular charging scenarios. For example, a first ML model may be used to predict SOC values for battery system 102 when battery characteristics are within a certain threshold range (e.g., when a SOH value of battery system 102 is between 71% and 85%) and a second ML model may be used to predict SOC values for battery system 102 when battery characteristics are within a certain threshold range (e.g., when a SOH value of battery system 102 is between 86% and 99%).

In some embodiments, e.g., prior to usage or model selection, multiple ML models may be evaluated (e.g., by ABM 108 or another entity) to determine which model; works best for certain scenarios and/or battery characteristics. For example, a GBR model may be generated using historical data (e.g., temperature, current, and voltage values for a battery cell of battery system 102 at different times and corresponding SOH values for those samples) as input to predict new output values (e.g., a SOC value of the battery cell of battery system 102 at each sample). In this example, a random forest regressor (RFR) model may also be using historical data (e.g., temperature, current, and voltage values for a battery cell of battery system 102 at different times and corresponding SOH values for those samples) as input to predict new output values (e.g., a SOC value of the battery cell of battery system 102 at each sample). Continuing with this example, ABM 108 or a related entity (e.g., an analyzer) may determine which of the two ML model should be used when the SOH value of battery system 102 is between 86% and 99%, e.g., by determining which ML model is more accurate (e.g., by comparing RMSEs values of different ML models and selecting the ML model with the lowest RMSE(s) or that never exceeds a threshold value (e.g., 5%).

In some embodiments, a GBR model (e.g., generated using a Python library or other code library) may be configured using various user-provided settings, e.g., a learning rate (e.g., a hyper parameter controlling weights in a model is adjusted with respect to a loss gradient at each step or iteration), an amount of N_estimators (e.g., a number of trees in a forest used for regression purposes), etc. In such embodiments, after configuration, the GBR model may be evaluated to obtain performance metrics, e.g., an R2 score (e.g., a metric that indicates the goodness of fit of a regression ML model) and an RMSE error maximum value (e.g., a metric that measures the average difference between values predicted by an ML model and the actual values).

In some embodiments, an RFR model (e.g., generated using a Python library or other code library) may be configured using various user-provided settings, e.g., an amount of N_estimators (e.g., a number of trees in a forest used for regression purposes). In such embodiments, after configuration, the GBR model may be evaluated to obtain performance metrics, e.g., an R-squared (R2) score (e.g., a metric that indicates the goodness of fit of a regression ML model) and an RMSE error value (e.g., a metric that measures the average difference between values predicted by an ML model and the actual values).

As shown, diagram 400 is a bar graph showing computed RMSE values for different battery cells (e.g., cells 0-3). In particular, RMSE values in diagram 400 are for a GBR model with a learning rate of 0.01, 190 N_estimators, an R2 score of 95%, and RMSE error max value of 5% and a RFR model with 100 N_estimators, an R2 score of 99%, and RMSE error value of 0.01%. Each light bar represents an RMSE value for a battery cell associated with an RFR model and each dark bar represents an RMSE value for a battery cell associated with a GBR model.

While the R2 Score of the RFR model of diagram 400 is 99%, this ML model leads to overfitting on tested data, so the GBR model of diagram 400 may be the ML model used when a SOH value of battery system 102 is between 86% and 99%, e.g., since the GBR model has an R2 score of 95% and the maximum RMSE value in cell 2 and cell 3 is not higher than 5%.

In some embodiments, ABM 108 or another entity may modify, test, and evaluate candidate models for different scenarios and, moreover, can replace or add models as additional information is collected or observed. For example, after testing various ML models, ABM 108 or another entity may determine that a KF model should be used when a SOH value of battery system 102 is between 71% and 85%

It will be appreciated that FIG. 4 is for illustrative purposes and that various functionality described above in relation to FIG. 4 may be changed, altered, added, or removed.

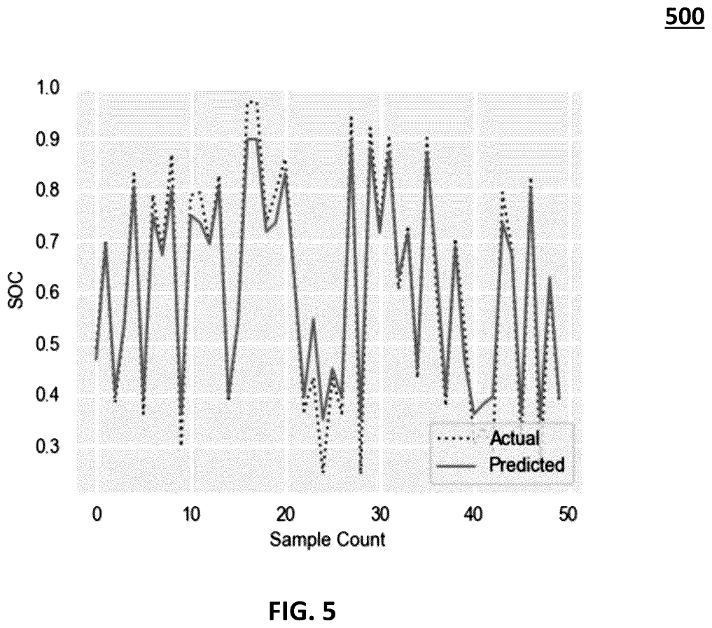

FIG. 5 is a diagram 500 illustrating actual SOC values for a battery cell and predicted SOC values using a GBR model. Diagram 500 is a line graph showing actual and predicted SOC values over a series of samples (e.g., observations at different times or computations therefrom). As shown in diagram 500, the solid line represents actual SOC values (e.g., values derived from predetermined data or values computed without an ML model, such as Coulomb counting) and a dashed line represents predicted SOC values generated by or using a GBR model (e.g., SOC prediction model 114). Although some predicted SOC values deviate from corresponding actual SOC values, a computed estimation error (e.g., an RMSE) may be within an acceptable threshold value or range, e.g., an RMSE value may be less than 5%.

It will be appreciated that FIG. 5 is for illustrative purposes and that various functionality described above in relation to FIG. 5 may be changed, altered, added, or removed.

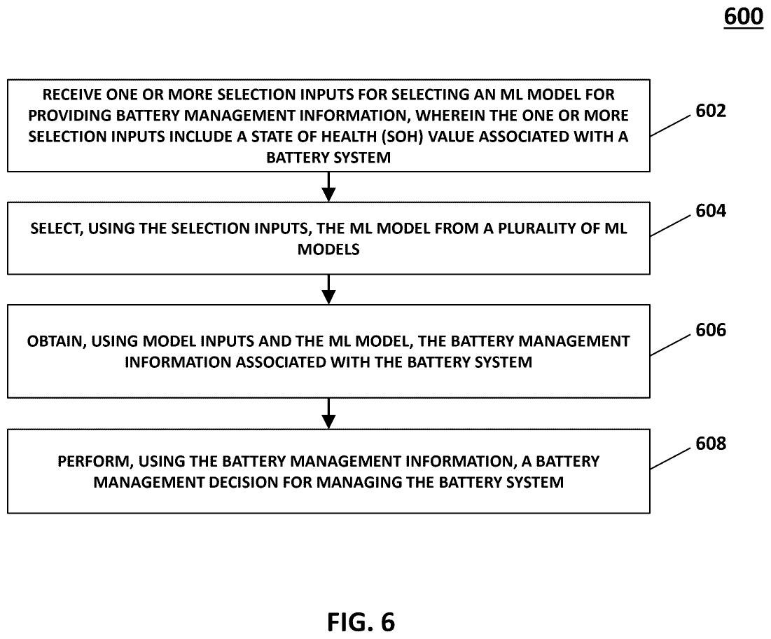

FIG. 6 is a block diagram illustrating an example process 600 for using an ML model in battery management. In some embodiments, example process 600 may include steps 602, 604, 606, and/or 608. In some embodiments, process 600, or portions thereof, may be performed by BMS 104, ABM 108, software or logic executing on a processor, and/or another node or module.

Referring to FIG. 6, in step 602, one or more selection inputs may be received for selecting an ML model (e.g., SOC prediction model 114) for providing battery management information. In some embodiments, selection inputs may include an SOH value associated with battery system 102. For example, battery system 102 may include an EV battery comprising multiple battery cells that is located on an EV chassis. In this example, battery sensors may provide battery characteristics (e.g., SOH value, voltage, current, and temperature of individual battery cells) to BMS 104 or a related entity (e.g., BC 106). Continuing with this example, BMS 104 or a related entity may provide this information or related information (e.g., averages or normalized values) to ABM 108 or a related entity (e.g., ML selector 112) for selecting an appropriate ML model. In some embodiments, selection inputs may also include time information, e.g., timestamps or other information to indicate changes of one or more battery characteristics over time.

In some embodiments, battery system 102 may include an EV battery, a battery bank, one or more batteries, or one or more battery cells.

In some embodiments, battery system 102 or battery sensors may be located in an electric vehicle or on a related chassis.

In step 604, the ML model may be selected, using the selection inputs, from a plurality of ML models. For example, ABM 108 or a related entity (e.g., ML selector 112) may use selection input (e.g., a SOH value associated with battery system 102) and related selection logic to determine which ML model to use for providing a SOC prediction or other battery management information.

In some embodiments, a plurality of ML models (e.g., available for use by ABM 108) may include a GBR model, an RFR model, or a KF model.

In some embodiments, a system (e.g., ABM 108, BMS 104, or a microservice or logic executing on a processor or chip) may be configured for determining whether a SOH value (e.g., SOH=78%) meets or exceeds a first threshold value (e.g., 71%) and is less than a second threshold value (e.g., 86%); and in response to determining that the SOH value meets or exceeds the first threshold value and is less than the second threshold value, selecting a first ML model (e.g., a KF model) of the plurality of ML models; in response to determining that the SOH value meets or exceeds the second threshold value, determining whether the SOH value is less than a third threshold value (e.g., 100%); and in response to determining that the SOH value meets or exceeds the second threshold value and is less than the third threshold value, selecting a second ML model (e.g., a GBR model) of the plurality of ML models.

In step 606, the battery management information associated with the battery system may be obtained using model inputs and the ML model. For example, model inputs may be the same input or similar to information used in ML selection, e.g., SOH value, voltage, current, and temperature of individual battery cells of battery system 102. In some embodiments, model inputs may also include time information, e.g., timestamps or other information to indicate changes of battery characteristics over time.

In step 608, a battery management decision for managing the battery system may be performing using the battery management information (e.g., a predicted SOC value). For example, after SOC prediction model 114 generates a predicted SOC value for battery system 102, ABM 108 or a related entity (SOC prediction model 114 or notifier 116) may provide or trigger a battery management decision (e.g., an alert to a user or GUI and/or may cause charging to be stopped), e.g., via BMS 104.

In some embodiments, performing a battery management decision for managing the battery system may include determining that a predicted SOC value indicates a low charge and, in response, notifying an entity that the battery system has a low charge.

In some embodiments, performing a battery management decision for managing the battery system may include determining that a predicted SOC value may be within an acceptable charging range and, in response, triggering a normal charging event and/or notifying an entity regarding the normal charging event.

In some embodiments, performing a battery management decision for managing the battery system may include determining that a predicted SOC value and/or a battery metric indicates a potential battery safety issue and, in response, triggering a mitigation event and/or notifying an entity regarding the mitigation event or the potential battery safety issue.

In some embodiments, a system (e.g., ABM 108, BMS 104, or logic executing on a processor or chip) may be configured for receiving an updated SOH value (e.g., SOH=68%) associated with battery system 102; determining that the updated SOH value indicates a battery system failure; and in response: notifying or alerting an entity (e.g., BC 106, an EV user, a GUI, a response system, etc.) regarding the battery system failure, and/or performing a battery management decision (e.g., stopping battery charging) for mitigating issues associated with the battery system failure.

In some embodiments, selection inputs or model inputs may include a temperature value, a current value, and/or a voltage value associated with the battery system.

In some embodiments, a system (e.g., ABM 108, BMS 104, or logic executing on a processor or chip) may be configured for monitoring the performance of an ML model (e.g., SOC prediction model 114) in real-time or near-real-time; determining that the performance of the ML model needs improvement; and, in response, updating the ML model to improve performance. For example, ABM 108 or another entity (e.g., MAU 118) may receive SOC prediction values from a GBR model over a period of time for battery system 102 and a set of actual SOC values over the same period of time for battery system 102 (e.g., from a data store, a detection mechanism, a battery manufacturer or tester, or another source).

In some embodiments, determining that the performance of an ML model needs improvement may involve computing one or more RMSE values associated with the ML model and determining that the RMSE values associated with the ML model are greater than an acceptable error threshold value.

In some embodiments, battery management information may include a predicted SOC value.

It will be appreciated that process 600 is for illustrative purposes and that different and/or additional actions may be used. It will also be appreciated that various actions described herein may occur in a different order or sequence.

It should be noted that BMS 104, ABM 108, and/or various modules, nodes, or functionality described herein may constitute a special purpose computing platform, device, or system. For example, BMS 104, ABM 108, may be a chip or module in an EV or other battery-powered device configured to perform various aspects described herein. Further, BMS 104, ABM 108, or functionality described herein can improve the technological field of battery testing, battery charging, battery safety, and/or battery management by providing various techniques, systems, methods, or mechanisms using an ML model (e.g., an adaptive SOC prediction model) in battery management.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for using a machine learning (ML) model in battery management, the method comprising:
receiving one or more selection inputs for selecting a machine learning (ML) model for providing battery management information, wherein the one or more selection inputs include a state of health (SOH) value associated with a battery system;
selecting, using the selection inputs, the ML model from a plurality of ML models;
obtaining, using model inputs and the ML model, the battery management information associated with the battery system; and
performing, using the battery management information, a battery management decision for managing the battery system.

2. The method of claim 1 wherein selecting the ML model includes:
determining whether the SOH value meets or exceeds a first threshold value and is less than a second threshold value;
in response to determining that the SOH value meets or exceeds the first threshold value and is less than the second threshold value, selecting a first ML model of the plurality of ML models;
in response to determining that the SOH value meets or exceeds the second threshold value, determining whether the SOH value is less than a third threshold value;
in response to determining that the SOH value meets or exceeds the second threshold value and is less than the third threshold value; and
selecting a second ML model of the plurality of ML models.

3. The method of claim 1 comprising:
receiving an updated SOH value associated with the battery system;
determining that the updated SOH value indicates a battery system failure; and
in response:
notifying or alerting an entity regarding the battery system failure, and/or
performing a battery management decision for mitigating issues associated with the battery system failure.

4. The method of claim 1 wherein the selection inputs or the model inputs include a temperature value, a current value, and/or a voltage value associated with the battery system.

5. The method of claim 1 wherein the battery system includes an electric vehicle battery, a battery bank, one or more batteries, or one or more battery cells.

6. The method of claim 1 wherein the battery system or battery sensors are located in an electric vehicle or on a related chassis.

7. The method of claim 1 wherein the plurality of ML models includes a gradient boosting regressor (GBR) model, a random forest regressor (RFR) model, or a Kalman filter (KF) model.

8. The method of claim 1 comprising:
monitoring the performance of the ML model in real-time or near-real-time;
determining that the performance of the ML model needs improvement; and
in response, updating the ML model to improve performance.

9. The method of claim 1 wherein the battery management information includes a predicted state of charge (SOC) value and performing the battery management decision for managing the battery system includes:
determining that the predicted SOC value indicates a low charge and, in response, notifying an entity that the battery system has a low charge;
determining that the predicted SOC value is within an acceptable charging range and, in response, triggering a normal charging event and/or notifying an entity regarding the normal charging event; and
determining that the predicted SOC value and/or a battery metric indicates a potential battery safety issue and, in response, triggering a mitigation event and/or notifying an entity regarding the mitigation event or the potential battery safety issue.

10. A system for using a machine learning (ML) model in battery management, the system comprising:
a memory; and
at least one processor,
wherein the system is configured for:
receiving one or more selection inputs for selecting a machine learning (ML) model for providing battery management information, wherein the one or more selection inputs include a state of health (SOH) value associated with a battery system;
selecting, using the selection inputs, the ML model from a plurality of ML models;
obtaining, using model inputs and the ML model, the battery management information associated with the battery system; and
performing, using the battery management information, a battery management decision for managing the battery system.

11. The system of claim 10 wherein the system is configured for:
determining whether the SOH value meets or exceeds a first threshold value and is less than a second threshold value;
in response to determining that the SOH value meets or exceeds the first threshold value and is less than the second threshold value, selecting a first ML model of the plurality of ML models;
in response to determining that the SOH value meets or exceeds the second threshold value, determining whether the SOH value is less than a third threshold value;
in response to determining that the SOH value meets or exceeds the second threshold value and is less than the third threshold value; and
selecting a second ML model of the plurality of ML models.

12. The system of claim 10 wherein the system is configured for:
receiving an updated SOH value associated with the battery system;
determining that the updated SOH value indicates a battery system failure; and
in response:
notifying or alerting an entity regarding the battery system failure, and/or
performing a battery management decision for mitigating issues associated with the battery system failure.

13. The system of claim 10 wherein the selection inputs or the model inputs include a temperature value, a current value, and/or a voltage value associated with the battery system.

14. The system of claim 10 wherein the battery system includes an electric vehicle battery, a battery bank, one or more batteries, or one or more battery cells.

15. The system of claim 10 wherein the battery system or battery sensors are located in an electric vehicle or on a related chassis.

16. The system of claim 10 wherein the plurality of ML models includes a gradient boosting regressor (GBR) model, a random forest regressor (RFR) model, or a Kalman filter (KF) model.

17. The system of claim 10 wherein the system is configured for:
monitoring the performance of the ML model in real-time or near-real-time;
determining that the performance of the ML model needs improvement; and
in response, updating the ML model to improve performance.

18. The system of claim 10 wherein the system is configured for determining that the performance of the ML model needs improvement by computing a root mean square error associated with the ML model and determining that the root mean square error associated with the ML model is a greater than an acceptable error threshold value.

19. The system of claim 10 wherein the battery management information include a predicted state of charge (SOC) value and performing the battery management decision for managing the battery system includes:
determining that the predicted SOC value indicates a low charge and, in response, notifying an entity that the battery system has a low charge;
determining that the predicted SOC value is within an acceptable charging range and, in response, triggering a normal charging event and/or notifying an entity regarding the normal charging event; and
determining that the predicted SOC value and/or a battery metric indicates a potential battery safety issue and, in response, triggering a mitigation event and/or notifying an entity regarding the mitigation event or the potential battery safety issue.

20. A non-transitory computer readable medium comprising computer executable instructions embodied in the non-transitory computer readable medium that when executed by a processor of a computer perform steps comprising:
receiving one or more selection inputs for selecting a machine learning (ML) model for providing battery management information, wherein the one or more selection inputs include a state of health (SOH) value associated with a battery system;
selecting, using the selection inputs, the ML model from a plurality of ML models;
obtaining, using model inputs and the ML model, the battery management information associated with the battery system; and
performing, using the battery management information, a battery management decision for managing the battery system.
